(19) United States
(12) Patent Application Publication
(10) Pub. No.: US 2013/0231798 A1
(43) Pub. Date: Sep. 5, 2013

(54) METHOD TO OPERATE A POWERTRAIN BY COMPARING HISTORICAL TO ACTUAL AMBIENT OPERATING CONDITIONS

(71) Applicants: Mark A. Zurawski, Northville, MI (US); Dennis M. Letang, Canton, MI (US)

(72) Inventors: Mark A. Zurawski, Northville, MI (US); Dennis M. Letang, Canton, MI (US)

(21) Appl. No.: 13/410,820

(22) Filed: Mar. 2, 2012

(51) Int. Cl. G06F 7/00

(52) U.S. Cl. 701/1

(57) ABSTRACT

A web based method and system to determine the ambient conditions and/or surrounding or affecting a remote object during its travel, such as a vehicle, animal or individual. The system and method include pulling data from the world wide web to determine the travel path of the vehicle. Data from a nearby weather station is used to ascertain the ambient conditions along the travel path. Historical weather data indicative of historical ambient conditions in a geographical location may be stored in memory and used as predictor for travel conditions to be expected and used as a basis for the operation of the vehicle. When weather data is received that is outside of the historical weather data by some predetermined statistically significant amount, the actual data is used to alter the operation of the vehicle during travel.

### TECHNICAL FIELD

Modern operation of powertrains take actual ambient operating conditions into account during operation. Such ambient were previously restricted to those conditions that could be discerned by sensor associated with the powertrain operation. With the advent of the world wide web (www), it should be possible to be in one location, or be travel along a route to a destination, and predict actual ambient operating conditions for the powertrain. By predicting actual ambient operating conditions, it is possible to efficiently modify the operation of a powertrain to improve efficiency.

Wi-Fi has become an increasingly reliable feature for use in remote locations, especially for vehicles as they travel from one location to another. With this advent, there is a need for a reliable system to facilitate on-location downloading of actual ambient operating conditions, such as weather, terrain and road conditions, along a travel route and using such information to modify the operation of the powertrain to afford an operator optimum performance for conditions encountered during travel.

### SUMMARY

In at least one embodiment, the disclosure is related to systems and methods to operate a powertrain based upon a comparison of historical operating data and actual operating data, and modifying the operation of the powertrain based upon a predetermined difference between the historical operating data and the actual operating data. The system may be a powertrain, or a vehicle with a powertrain, the powertrain in each instance associated with an electronic control module (ECU) having a memory, or other computer readable media (CRM), having access to historical data and able to compare that historical operating data to actual operating data and modify the operation of the powertrain based upon that comparison.

One method according to this disclosure may include determining a geographical location of the powertrain, operating the powertrain according to predetermined parameters based upon historical ambient conditions data for a given geographical location stored in memory of an ECU, or other CRM associated with the powertrain, determining actual ambient conditions data in the geographical location, comparing the actual ambient conditions data to the stored historical ambient conditions data for a given geographical location, and modifying the powertrain operation when data of at least one actual ambient condition differs from the historical ambient conditions data by a predetermined amount.

In at least one disclosed method and system, the historical ambient conditions and the actual ambient condition data my include at least one of barometric pressure, temperature, altitude, air density, wind speed, wind direction, rainfall, powertrain speed, powertrain torque, fuel consumption, daylight hours, night hours, periods of sunshine, periods of overcast clouds, humidity, and terrain configuration. The actual ambient conditions may be available to the ECU or CRM via a web based server, such as, for example, any weather provider, or proprietary web based servers such as Zonar, from Zonar Systems, and Wundersearch, available from Wunderground.

The powertrain may be at least one of internal combustion engines, hybrid electric powertrains, electric motors, fuel cell power plants, solar powered generator, wind powered generator.

In another aspect the disclosure is related to a method and system to operate a vehicle having a powertrain associated with an ECU or other CRM. The method may include determining a geographical location of said vehicle, determining a travel path of the vehicle, operating the powertrain according to predetermined parameters based upon historical ambient conditions data for the geographical location stored in memory of the ECU or CRM, determining actual ambient conditions data along the vehicle travel path, comparing the actual ambient conditions data to the stored historical ambient conditions data for said geographical location, and modifying said powertrain operation when data of at least one actual ambient condition differs from said historical ambient conditions data by a predetermined amount.

The historical ambient conditions data and the actual conditions data includes at least one of barometric pressure, temperature, altitude, air density, wind speed, wind direction, rainfall, powertrain speed, powertrain torque, fuel consumption, daylight hours, night hours, periods of sunshine, periods of overcast clouds, humidity, vehicle speed, road speed, vehicle travel direction, road conditions and terrain configuration.

The powertrain may be at least one of internal combustion engines, hybrid electric powertrains, electric motors, and fuel cell power plants.

These and other aspects of the disclosure will become apparent upon a reading of the description and the appended claims.

### BRIEF DESCRIPTION OF THE DRAWINGS

FIG. 1 is a schematic representation of a vehicle with a powertrain as it travels according to one aspect of the disclosure

FIG. 2 is a representation of a test travel path of a vehicle equipped according to the present disclosure

FIG. 3 is a representation of a a graph showing Historical Temperature, Estimated Temperature and Actual Temperature along the travel path of FIG. 2

FIG. 4 is a software flow chart showing one method of operation according to the present disclosure.

### DETAILED DESCRIPTION

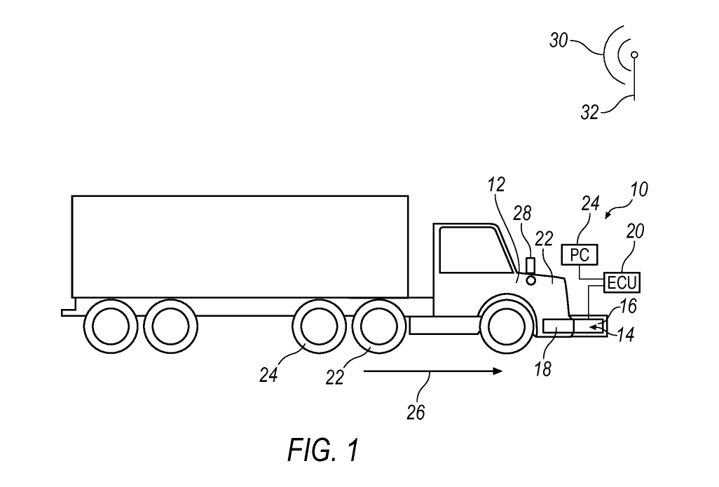

Turning now to the drawings wherein like numbers refer to like structures, FIG. 1 is a schematic representation of a one aspect of the system 10 including a vehicle 12 having a powertrain 14, which may be an engine 16 coupled to a transmission 18. The Engine may have an electronic control unit (ECU) 20 in association with the engine, that may utilize memory such as PROM, EPROM EEPROM, FLASH or any other memory to store information for processing. In this representation it is understood that an internal combustion engine has a fuel system that may be controlled by the ECU, and the engine operates according to operating instructions held memory by the ECU. A suitable internal combustion engine may be a compression ignition engine, and may utilize the DDEC operating system available from Detroit Diesel Corporation, or any other operating system. In this regard, it is further contemplated that any computer readable medium (CRM) may also be used, provided there are sufficient instructions to operate the engines or powertrain. The engine may be an internal combustion engine, a fuel cell power plant, a Hybrid Electric Vehicle powertrain, or an electric motor.

The engines is coupled to a transmission to translate rotary power from the engine drive shaft for transmission through various gears as is known in the art, to power at least the wheels 22, 24, to propel the vehicle as is well known in the art. The vehicle may travel in the direction of travel 26, or in any direction the operator may choose. The vehicle may further be equipped with a transceiver 28 (which may be a transmitter and receiver, or just a receiver) to receive signals 30 from a local Wi-Fi provider, shown schematically at 32. The Wi-Fi signals may pass through a personal computer (PC) 34 controlled by the operator, or may be received directly into the ECU.

As the vehicle travels along travel direction 26, the ECU or CRM controls the operation of the powertrain by way of operating instructions held in memory by the controller. The operating instructions further include tables or maps, populated with fueling strategies and other operating conditions and are used b the engine at various times in its operation. These may include historical parameters for a given travel rout or location, such as, for example, terrain configuration, engine torque, engine speed, fueling consumption, air density, road speed, vehicle speed, wheel speed, air density, barometric pressure, altitude, precipitation, temperature, or any other operating parameters. Many of these parameters are local in nature, and may need constant updating in order to maximize operating efficiency of powertrain. By way of Wi-Fi signal, an operator may, through a personal computer (PC) learn the road conditions as set forth above along the travel route intended, and download those actual operating parameters via the PC into the ECU or CRM. Web servers that provide a service to assist fleet owners to track their fleets include Zonar from Zonar Corporation and Wunderground, from Wundersearch Inc. If the new actual operating parameters differ from the preset historical operating parameters by a predetermined amount, an estimated ambient operating condition is created and the operating parameters are updated in the engine operating software, and the powertrain can be tailor operated according to these new parameters.

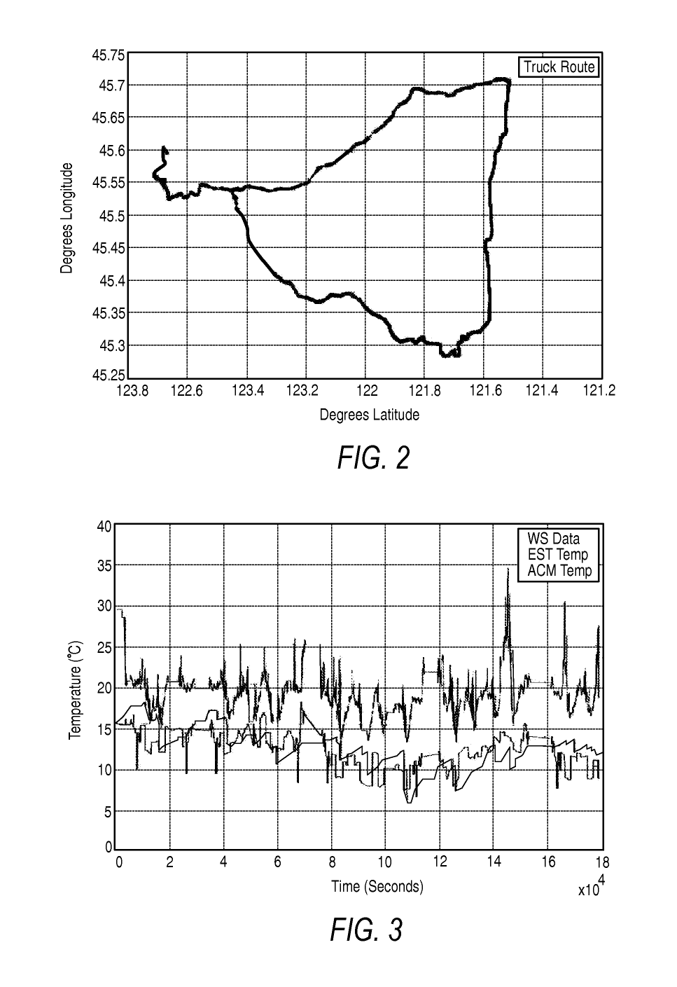

FIG. 2 depicts the travel path of a vehicle in one method of the present disclosure. The X axis 36 represents latitude and is given in degrees. The Y axis 38 represents longitude and is given in degrees. The vehicle route 40 is shown, and as can be seen by examining the FIG. key 42, the entire route took 14 miles.

Turning now to FIG. 3, there is shown a representation of a graph 44 depicting the historical temperature 46, the estimated temperature 48 and the actual temperature 50. The X axis 52 is Time in seconds, and the y axis 54 is Temperature in Celsius. As can be seen in FIG. 3, the historical temperatures plotted and held in memory of the ECU. It averages about 20 degrees Celsius. However, the actual temperature is about 15 degrees Celsius. Since the difference between the historical temperature and the actual temperature is more than a predetermined amount, the estimated temperature the ECU assumes for operating condition of the vehicle closely matches the actual temperature, and operating efficiency of the engine is enhanced.

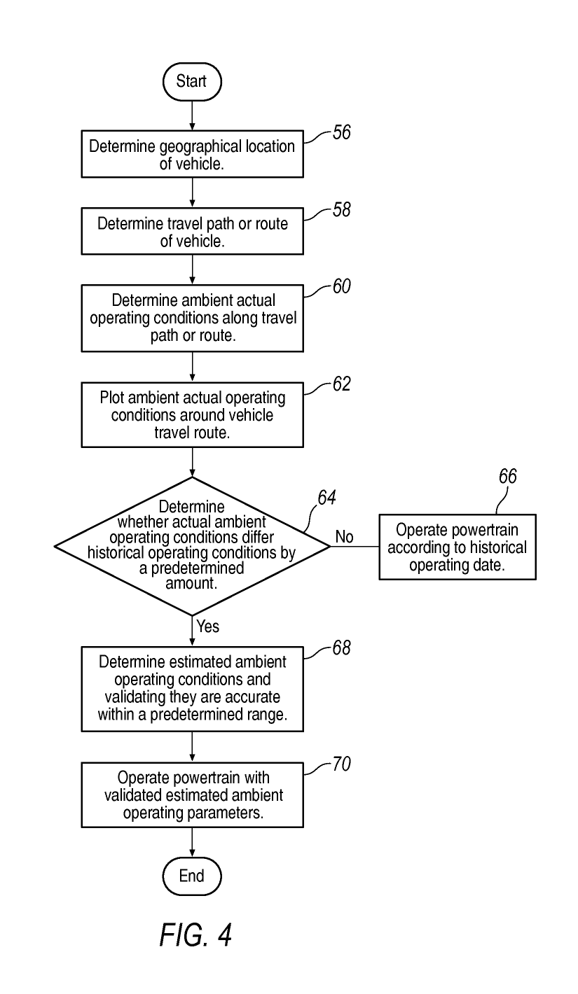

FIG. 4 is a schematic representation of a software flow diagram for one method 54 according to the present disclosure. Specifically, step 56 is determining the geographical location of the vehicle. This may be done by GPS or by Wi-Fi service such as Zonar or Wunderground, or by any other means to determine the geographical location of an object. Step 58 is determining the travel path or route of the vehicle. This may be done by GPS or by pre-recording the travel path of the vehicle into a controller or PC, and perhaps downloading the path into the ECU or CRM. Step 60 is determining the weather or ambient actual operating conditions along the selected travel route. Again, this may be done in any number of ways such as is well known to those skilled in the art, or the weather or ambient actual operating conditions along the route may be provided by Wi-Fi service providers, such as Zonar and Wunderground. An optional step 62 is to plot the ambient actual operating conditions around the vehicle along the travel route or path and step 64 is to determine whether the actual ambient operating conditions exceed the historical operating conditions by a predetermined amount, and if yes, then step 66 is determining estimated ambient operating conditions and validating whether the estimated ambient operating conditions are accurate within a specified range and then use that estimated ambient operating condition to operate the powertrain. The estimate may then be stored in memory to create a log for the trip. In the event the trip is related, it may be possible to look over any period of time, (for example, a year to year comparison) to get historical operating conditions about the ambient actual operating conditions on the travel route and then update programming on the ECU or CRM.

While at least one system and method have been detailed, those skilled in the art recognize that the specification discloses words of description and not limitation. Many variations and modifications are apparent to those skilled in the art, and the invention is not limited except as set forth in the appended claims.

What is claimed as new and desired to be protected by Letters Patent of the United States is:

1. A method to operate a powertrain, comprising:
determining a geographical location of said powertrain;
operating said powertrain according to predetermined parameters based upon historical ambient conditions data for a given geographical location stored in memory of an Electronic Control Unit (ECU) associated with said power train;
determining actual ambient conditions data in said geographical location;
comparing said actual ambient conditions data to said stored historical ambient conditions data for a given geographical location to create estimated ambient operating conditions data;
determining whether the estimated ambient operating conditions data is accurate within a predetermined range; and
modifying said powertrain operation when data of at least one actual ambient condition differs from said historical ambient conditions data by a predetermined amount.

2. The method of claim 1, wherein said historical ambient conditions data includes at least one of barometric pressure, temperature, altitude, air density, wind speed, wind direction, rainfall, powertrain speed, powertrain torque, fuel consumption, daylight hours, night hours, periods of sunshine, periods of overcast clouds, humidity, and terrain configuration.

3. The method of claim 1, wherein said actual ambient condition data includes at least one of barometric pressure, temperature, altitude, air density, wind speed, wind direction, rainfall, powertrain speed, powertrain torque, fuel consumption, daylight hours, night hours, periods of sunshine, periods of overcast clouds, humidity, and terrain configuration.

4. The method of claim 1, wherein said powertrain may be at least one of internal combustion engines, hybrid electric powertrains, electric motors, fuel cell power plants, solar powered generator, wind powered generator,

5. The method of claim 1, wherein said parameters are received on a personal computer and uploaded into the powertrain operating conditions by said personal computer.

6. The method of claim 1, wherein at least one actual operating parameter is available via a wireless/data connection.

7. A method to operate a vehicle having a powertrain associated with an electronic control unit (ECU), comprising:
determining a geographical location of said vehicle;
determining a travel path of said vehicle;
operating said powertrain according to predetermined parameters based upon historical ambient conditions data for said geographical location stored in memory of said ECU;
determining actual ambient conditions data along said travel path;
comparing said actual ambient conditions data to said stored historical ambient conditions data for said geographical location to create estimated ambient operating conditions data;
determining whether the estimated ambient operating condition data is accurate within a predetermined range; and
modifying said powertrain operation when data of at least one actual ambient condition differs from said historical ambient conditions data by a predetermined amount.

8. The method of claim 7, wherein, wherein said historical ambient conditions data includes at least one of barometric pressure, temperature, altitude, air density, wind speed, wind direction, rainfall, powertrain speed, powertrain torque, fuel consumption, daylight hours, night hours, periods of sunshine, periods of overcast clouds, humidity, vehicle speed, road speed, vehicle travel direction, road conditions and terrain configuration.

9. The method of claim 7, wherein said actual ambient condition data includes at least one of barometric pressure, temperature, altitude, air density, wind speed, wind direction, rainfall, powertrain speed, powertrain torque, fuel consumption, daylight hours, night hours, periods of sunshine, periods of overcast clouds, humidity, vehicle speed, road speed, vehicle travel direction, road conditions and terrain configuration.

10. The method of claim 7, wherein said powertrain may be at least one of internal combustion engines, hybrid electric powertrains, electric motors, and fuel cell power plants.

11. A computer readable medium having instructions for determining a geographical location of a powertrain;
operating said powertrain according to predetermined parameters based upon historical ambient conditions data for a given geographical location stored in memory of an Electronic Control Unit (ECU) associated with said power train;
determining actual ambient conditions data in said geographical location;
comparing said actual ambient conditions data to said stored historical ambient conditions data for a given geographical location to create estimated ambient operating conditions data;
determining whether the estimated ambient operating conditions data is accurate within a predetermined range; and
modifying said powertrain operation when data of at least one actual ambient condition differs from said historical ambient conditions data by a predetermined amount.

12. The method of claim 11, wherein, wherein said historical ambient conditions data includes at least one of barometric pressure, temperature, altitude, air density, wind speed, wind direction, rainfall, powertrain speed, powertrain torque, fuel consumption, daylight hours, night hours, periods of sunshine, periods of overcast clouds, humidity, vehicle speed, road speed, vehicle travel direction, road conditions and terrain configuration.

13. The method of claim 11, wherein said actual ambient condition data includes at least one of barometric pressure, temperature, altitude, air density, wind speed, wind direction, rainfall, powertrain speed, powertrain torque, fuel consumption, daylight hours, night hours, periods of sunshine, periods of overcast clouds, humidity, vehicle speed, road speed, vehicle travel direction, road conditions and terrain configuration.

14. The method of claim 11, wherein said powertrain may be at least one of internal combustion engines, hybrid electric powertrains, electric motors, and fuel cell power plants.
